(19) United States
(12) Patent Application Publication
(10) Pub. No.: US 2014/0009954 A1
(43) Pub. Date: Jan. 9, 2014

(54) INDOOR LIGHTING DEVICE FOR VEHICLE

(71) Applicant: Shinji Mochizuki, Makinohara-shi (JP)

(72) Inventor: Shinji Mochizuki, Makinohara-shi (JP)

(73) Assignee: YAZAKI CORPORATION, Tokyo (JP)

(21) Appl. No.: 14/006,812

(22) PCT Filed: May 11, 2012
(86) PCT No.: PCT/JP2012/062732

§ 371 Date: Sep. 23, 2013

(30) Foreign Application Priority Data
May 12, 2011 (JP) 2011-107472

(51) Int. Cl. B60Q 3/02

(52) U.S. Cl. CPC B60Q 3/0203
USPC 362/546

(57) ABSTRACT

A bus bar includes switch connecting terminals connected to a switch, roof harness connecting terminals connected to a roof harness and pressure contact terminal parts which connect an electric wire under a pressure contact. The switch connecting terminals are arranged so as to protrude to a frontage for a switch of a housing. The pressure contact terminal parts are arranged so as to protrude to an electric wire holder attaching part. A clamp member is provided in the housing. A part of the clamp member is cut out to form an electric wire attaching opening through which the electric wire passes. An electric wire holder attaching part and the electric wire attaching opening are arranged so as not to correspond to a wiring direction of the electric wire. The electric wire is allowed to pass through an inside of the clamp member so as to be clamped.

### TECHNICAL FIELD

The present invention relates to a part called a functional part which is provided with an indoor lighting device for a vehicle mounted on a ceiling part in a vehicle, especially, functional parts such as an LED or a switch.

### BACKGROUND ART

An indoor lighting device is provided in a ceiling part of a motor vehicle. As one example, the indoor lighting device disclosed in PTL 1 is known. The lighting device for a vehicle is provided for the purpose of smoothly attaching a switch without difficulty and assuredly preventing the switch which is attached once from slipping out. The lighting device for the vehicle is attached to, for instance, the ceiling part of the vehicle.

In the lighting device for the vehicle disclosed in the patent literature, a guide wall 116 is provided in the periphery of a switch device to guide an insertion from an inlet to an interior part. In a protecting cover 140, an engaging protrusion is provided which is engaged with a protrusion 124 of a main body case 21 side of a switch 120 to prevent the switch from slipping out and a bulb pressing wall 147 is provided for guiding an insertion of a bulb 50.

Namely, this indoor lighting device includes, as shown in FIG. 9 of PTL1, a housing 10 made of a resin, a switch 20 for turning on and off a light source, a bus bar 30 forming a circuit, a protecting cover 40 made of a resin and the bulb 50 (an electric lamp) as a light source.

As shown in FIG. 10, the housing 10 has a substantially flat bottom plate 15 so that parts may be mounted on an upper side thereof. The housing 10 includes a bulb attaching part 11 for attaching the bulb 50 obliquely from an upper part in one end side and a switch attaching part 13 for attaching the switch 20 from a side part in the other side and has a bus bar attaching part 12 between the bulb attaching part 11 and the switch attaching part 13.

Further, as shown in FIG. 9 of PTL1, the bus bar 30 is attached to the bus bar attaching part 12 of the housing 10 from an upper part. The bus bar 30 includes an electrode 31 electrically connected to the bulb 50 attached to the bulb attaching part 11 in one end side and a terminal 33 electrically connected to the switch 20 attached to the switch attaching part 13 in the other end side, and has an electric wire pressure contact part 32 for connecting an electric wire by a pressure contact process in an intermediate part of the electrode 31 and the terminal 33.

As shown in FIG. 9 and FIG. 11(b) of PTL1, the protecting cover 40 serves to protect the electric wire pressure contact part 32 of the bus bar 30, and is attached and fixed to the housing 10 so as to cover the bus bar attaching part 12 after a pressure contact process of the electric wire and an attachment of the bulb 50. In one end side and the other end side of the protecting cover 40, extending walls 41 and 43 are provided so as to protrude to the bulb attaching part 11 or the switch attaching part 13 side.

The switch 20 of the indoor lighting device is an alternate type push switch (a type that ON/OFF are alternately switched every time the switch is pushed once). As shown in FIG. 11(a) of PTL1, the switch 20 has a main body case 21 in a lower part, a cylindrical part 22 thereon and a push button 25 thereon.

Further, in the switch 20 in the indoor lighting device, a base part which is inserted into the bulb attaching part 11 of the housing 110 by using a bulb pressing wall 147 of the protecting cover 140 as a guide is held by a spring part of the electrode 31.

### CITATION LIST

### Patent Literature

[PTL 1] JP-A-2010-205617

### SUMMARY OF INVENTION

### Technical Problem

In the above-described indoor lighting device for the vehicle of a usual example disclosed in the PTL 1, there is a possibility in that the electric wire is liable to slip off from the housing.

Further, in the indoor lighting device for the vehicle of the usual example disclosed in the PTL 1, there is a possibility in that serviceability is not good when the switch is attached to the housing.

### Solution to Problem

The present invention has been made in view of the situations that are described above, and it is an object of the present invention is to provide an indoor lighting device which makes it possible to hardly slip off an electric wire from housing.

Further, it is another object of the present invention to provide an indoor lighting device for a vehicle which can improve workability when a switch is attached to housing.

In order to achieve the objects, according to a first aspect of the present invention, an indoor lighting device for a vehicle in which an LED unit to which an LED is attached is attached to a housing and a bus bar holder to which a bus bar is fixed for electrically connecting the LED to a roof harness is attached to the housing to turn on the LED and light an interior of the vehicle. The indoor lighting device for a vehicle is characterized in that the bus bar includes switch connecting terminals provided in one end side which are electrically connected to a switch, roof harness connecting terminals electrically connected to the roof harness wired in the ceiling of an interior of the vehicle to receive a supply of power and pressure contact terminal parts provided in an intermediate part of the switch connecting terminals and the roof harness connecting terminals to connect an electric wire under a pressure contact, the switch connecting terminals of the bus bar are arranged so as to protrude to a frontage for the switch of the housing, the pressure contact terminal parts of the bus bar are arranged so as to protrude to an electric holder attaching part of the housing, a clamp member is provided in the housing, a part of the clamp member is cut out to form an electric wire attaching opening through which the electric wire passes, an electric wire holder attaching part of the LED unit and the electric wire attaching opening of the housing are arranged so as not to correspond to a wiring direction of the electric wire, and the electric wire is allowed to pass through an inside of the clamp member so as to be clamped.

According to the first aspect of the present invention, the electric wire can be hardly slipped off from the housing.

According to a second aspect of the present invention, in the indoor lighting device for a vehicle according to the first aspect of the present invention, the bus bar includes the switch connecting terminals, the switch connecting terminals are arranged so as to be exposed to the frontage for the switch of the housing, the switch is attached to the housing so that the switch connecting terminals are connected and fixed to terminal parts of the switch, and the clamp member forms a guide part in the direction of height when the switch is attached to the frontage for the switch of the housing.

According to the second aspect of the present invention, workability can be improved when the switch is attached to the housing.

According to a third aspect of the present invention, in the indoor lighting device for a vehicle according to the first aspect of the present invention, in the frontage for the switch of the housing, switch fixing lock members and are formed to protrude inside both wall surfaces and the switch fixing lock members and form a guide part by holding the switch together with the clamp member when the switch is attached to the frontage for the switch of the housing.

According to the third aspect of the present invention, the workability can be more improved when the switch is attached to the housing.

### Advantageous Effects of Invention

According to the present invention, the electric wire can be hardly slipped off from the housing.

Further, according to the present invention, the workability can be improved when the switch is attached to the housing.

### BRIEF DESCRIPTION OF DRAWINGS

FIG. 1 is an entire perspective view showing an embodiment of an indoor lighting device for a vehicle according to the present invention.

FIG. 2 is an entire perspective view of the indoor lighting device for a vehicle shown in FIG. 1 which is seen from an inner side of a vehicle room.

FIG. 3 is an exploded perspective view of an LED lamp sub-assay of the indoor lighting device for a vehicle shown in FIG. 1.

FIG. 4 is an exploded perspective view of a housing sub-assay of the LED lamp sub-assay shown in FIG. 3.

FIG. 5 is a diagram showing a state that a bus bar is attached to a bus bar holder shown in FIG. 4.

FIG. 6 is a diagram showing a state that the bus holder to which the bus bar is attached is attached to a housing shown in FIG. 4.

FIG. 7 is a plan view of the housing sub-assay showing a state that the bus holder to which the bus bar is attached is attached to the housing shown in FIG. 4.

FIG. 8 is a diagram showing a procedure for attaching a switch to the housing of the indoor lighting device for a vehicle.

FIG. 9 is a diagram showing a procedure for attaching the switch to the housing of the indoor lighting device for a vehicle.

FIG. 10 is a diagram showing a procedure for attaching the switch to the housing of the indoor lighting device for a vehicle.

FIG. 11 is a diagram showing an attachment of a connecting unit for connecting the LED lamp sub-assay of the indoor lighting device for a vehicle shown in FIG. 1 to an LED unit sub-assay and an attachment of the LED unit sub-assay.

FIG. 12 (A) is an entire perspective view of an electric wire holder shown in FIG. 11 before the electric wires are folded back and bent.

FIG. 12 (B) is an entire perspective view of an electric wire holder shown in FIG. 11 after the electric wires are folded back and bent.

FIG. 13 is an exploded perspective view showing the structure of an LED unit attached to the indoor lighting device for a vehicle shown in FIG. 1.

FIG. 14 is a view for explaining that an electric wire of a connecting unit is accommodated in an electric wire accommodating part in a housing shown in FIG. 13.

### DESCRIPTION OF EMBODIMENTS

Now, referring to the drawings, a preferred embodiment of a connecting structure of electronic parts and a connecting unit of electronic parts will be described below in detail.

The present invention includes a switch connecting terminal provided in one end side for electrically connecting a bus bar to a switch, a roof harness connecting terminal electrically connected to a roof harness wired in a ceiling in an interior of a vehicle to receive a supply of power and a pressure contact terminal part provided in an intermediate part of the switch connecting terminal and the roof harness connecting terminal to connect an electric wire by a pressure contact operation. The switch connecting terminal of the bus bar is arranged to protrude to a frontage for the switch of a housing. The pressure contact terminal part of the bus bar is arranged to protrude to an electric wire holder attaching part of the housing. A clamp member is provided in the housing. A part of the clamp member is cut out to form an electric wire attaching opening through which an electric wire is allowed to pass. An electric wire holder attaching part of an LED unit and the electric wire attaching opening of the housing are arranged so as not to correspond to a wiring direction of the electric wire. Thus, the electric wire is allowed to pass through an inside of the clamp member and clamped.

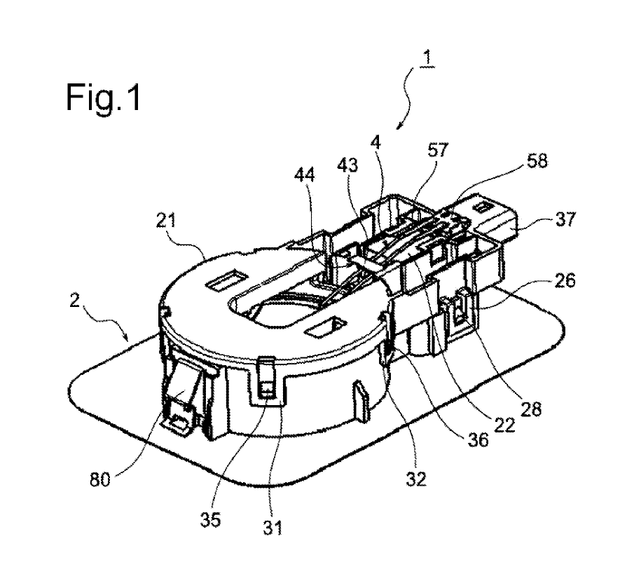

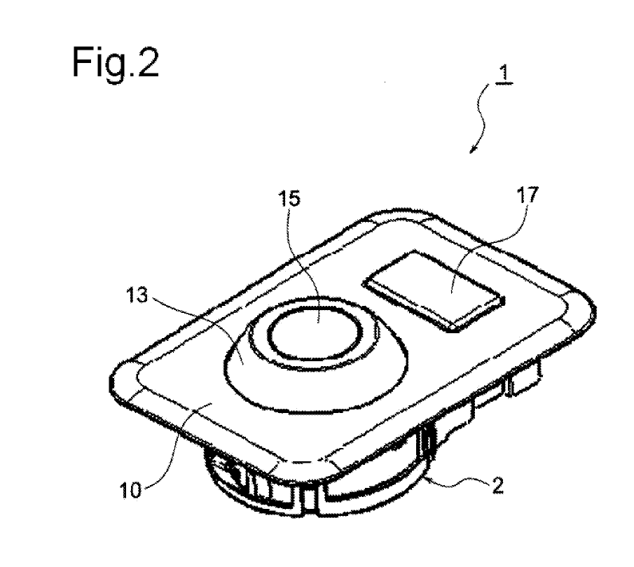

FIGS. 1 and 2 show an embodiment of an indoor lighting device for a vehicle. FIG. 1 is an entire perspective view of the indoor lighting device for a vehicle. FIG. 2 is an entire perspective view of the indoor lighting device for a vehicle shown in FIG. 1 which is seen from an inner side of a vehicle room.

In FIG. 1 and FIG. 2, the indoor lighting device for a vehicle 1 includes an LED lamp sub-assay 2 to which an LED as a light source of an indoor illumination of the vehicle, an LED unit sub-assay and a connecting unit 4 that connects the LED lamp sub-assay 2 to the LED unit sub-assay.

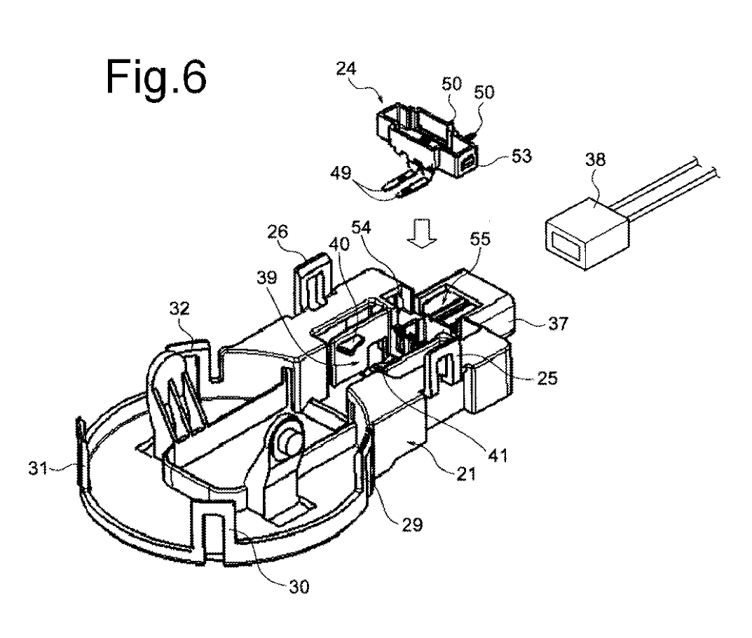

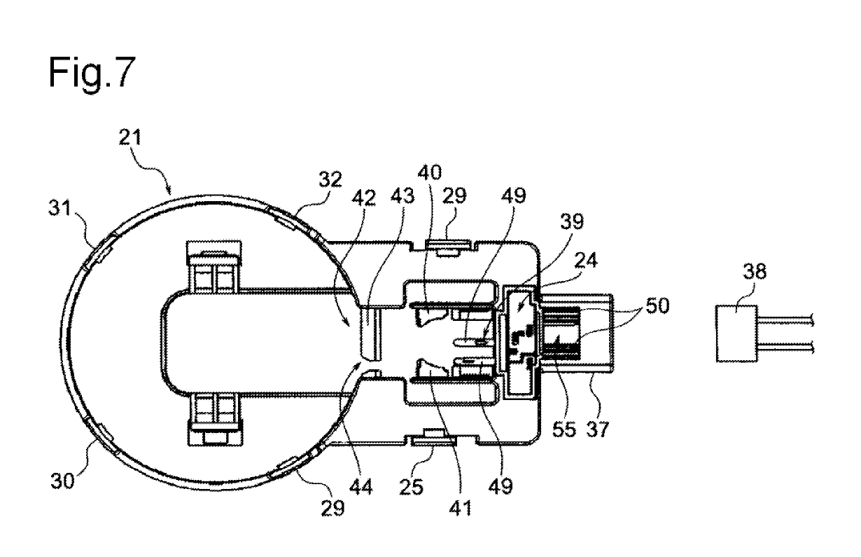

The LED lamp sub-assay 2 is a lighting device attached to a ceiling of an interior of the vehicle as the light source of the indoor illumination of the vehicle. In the LED lamp sub-assay 2, a connector frontage 55 is formed for connecting a roof W/H to which a connector 38 (see FIG. 6 and FIG. 7) having a harness connected is attached in order to connect a roof harness.

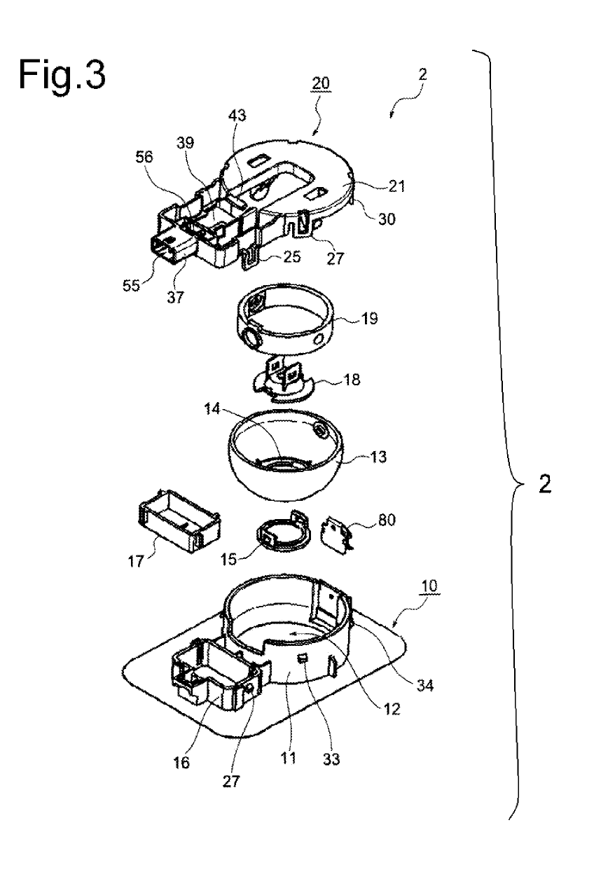

FIG. 3 shows an entire part of the LED lamp sub-assay 2.

In the drawing, the LED unit sub-assay includes a vessel for a roof 10 formed in the shape of a plate which is attached to the ceiling of the interior of the vehicle.

In the vessel for the roof 10, a ring member 11 formed in the shape of a flange is provided. In the vessel for the roof 10, a through hole 12 is formed correspondingly to the ring member 11. To the through hole 12, a lighting vessel 13 formed in the shape of a bowl is attached.

The lighting vessel 13 serves to change a direction of light of the light source (the LED) to be attached. On a bottom part in a center of the lighting vessel 13, a hole 14 is provided and a design lens 15 is attached to the hole 14.

Further, in the vessel for the roof 10, a switch knob attaching part 16 is formed adjacently to the ring member 11. To the switch knob attaching part 16, a switch knob 17 is attached. To the switch knob 17, a below-described switch 22 is attached.

Further, to the design lens 15 attached to the lighting vessel 13, an LED unit holder 18 that holds an LED unit 100 is attached. The interior of the vehicle is irradiated with lights emitted by an LED 107 of the LED unit 100 held by the LED unit holder 18 through the design lens 15.

The LED lamp sub-assay 2 has a ring shaped guide member 19 in order to attach the lighting vessel 13 to the through hole 12 of the vessel for the roof 10 without a trouble and fix the attached state after the lighting vessel 13 is attached to the ring member 11. The guide member 19 is attached inside the ring member 11 to fix the vessel for the roof 10.

Further, the LED lamp sub-assay 2 has a housing sub-assay 20 attached so as to cover the ring member 11 and the switch knob attaching part 16 of the vessel for the roof 10 from an upper part in FIG. 3.

In the drawing, reference numeral 80 designates a clip which is attached to the ring member 11 to fix a housing 21 of the housing sub-assay 20 to the ring member 11.

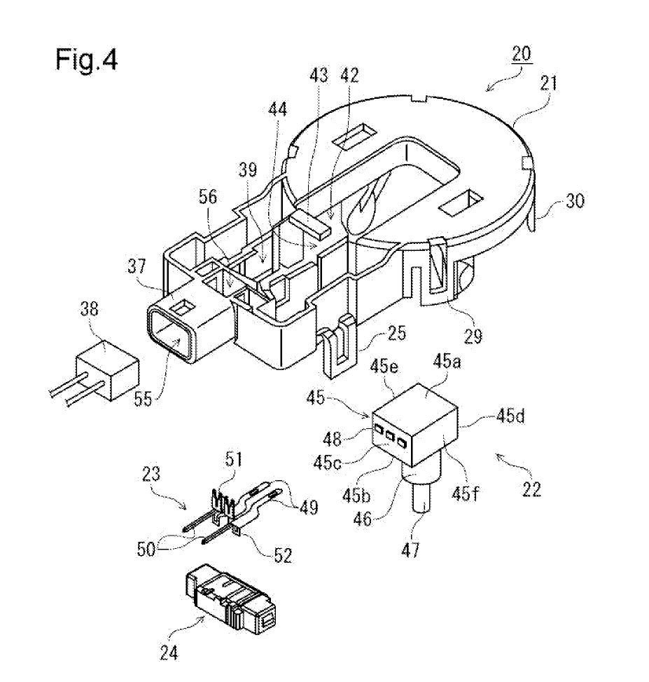

FIG. 4 shows an entire part of the housing sub-assay 20.

In the drawing, the housing sub-assay 20 includes the housing 21, the switch 22, a bus bar 23 and a bus bar holder 24.

After the switch 22, the bus bar 23 and the bus bar holder 24 are attached, the lighting vessel 13 to which the design lens 15 shown in FIG. 3 is attached is attached. After the guide member 19 is attached to an upper end edge of the lighting vessel 13, the housing 21 is attached to the ring member 11 provided in the vessel for the roof 10 shown in FIG. 3 so as to cover the ring member from an upper part.

The housing 21 includes one pair of right and left engaging members 25 and 26 in a side that covers the switch knob attaching part 16 of the vessel for the roof 10. The engaging members 25 and 26 are engaged with engaging protrusions 27 and 28 provided in the switch knob attaching part 16 of the vessel for the roof 10 and fixed to the vessel for the roof 10.

Further, the housing 21 includes engaging members 29, 30, 31 and 32 in a side that covers the ring member 11 of the vessel for the roof 10. The engaging members 29, 30, 31 and 32 are engaged with engaging protrusions 33, 34, 35 and 36 provided on an outer peripheral surface of the ring member 11 of the vessel for the roof 10 and fixed to the vessel for the roof 10.

In an end of the housing 21 in the side that covers the switch knob attaching part 16, a roof harness connector connecting part 37 is provided. To the roof harness connector connecting part 37, a roof harness connector 38 is attached.

In a part of the roof harness connector connecting part 37 of the housing 21 near the ring member 11, a frontage 39 for the switch is provided for attaching the switch 22. To the frontage 39 for the switch, the switch 22 can be attached from a lower side.

As shown in FIG. 6, in a side of the housing 21 for inserting the switch 22, switch fixing lock members 40 and 41 are provided which protrude inside on both wall surfaces of the frontage 39 for the switch to fix the switch 22. When the switch 22 is accommodated in the frontage 39 for the switch, the switch 22 is fixed by the switch fixing lock members 40 and 41.

Further, in the housing 21, an electric wire accommodating part 42 is formed which accommodates an electric wire for connecting the switch 22 to the LED unit 100. In the electric wire accommodating part 42, a rod shaped clamp member 43 is provided which protrudes to a center of the electric wire accommodating part 42 on a wall surface opposite to a side in which the switch fixing lock members 40 and 41 are provided.

In the clamp member 43, an electric wire attaching opening 44 is provided as an opening that allows the electric wire for connecting the switch 22 to the LED unit 100 to pass at a position which shifts either right or left from a central axis of the housing 21.

The switch 22 is formed as, for instance, an alternate type push switch that ON/OFF are alternately switched every time the switch is pushed once. The switch 22 has a main body case 45 in an upper part, a cylindrical part 46 under the main body case 45 and a push button 47 under the cylindrical part 46. The main body case 45 has a rectangular parallelepiped box form including an upper wall 45a, a lower wall 45b, a front wall 45c, a rear wall 45d and right and left side walls 45e and 45f.

Further, in the switch 22, terminal insert holes 48 are provided into which switch connecting terminals 49 as male type terminals of the bus bar 23 are inserted in the front wall 45c. The switch connecting terminals 49 of the bus bar 23 are inserted into the terminal insert holes 48 of the switch 22 to connect the switch 22 to the bus bar 23.

In one end side of the bus bar 23, the switch connecting terminals 49 are provided which are inserted into the terminal insert holes 48 formed in the front wall 45c of the switch 22 attached to the frontage 39 for the switch and are electrically connected to the switch 22.

In the other end side of the bus bar 23, roof harness connecting terminals 50 are provided which are electrically connected to terminals of the roof harness connector 38 to which a wire harness wired in the ceiling of the interior of the vehicle is connected to receive the supply of a power.

Further, in the bus bar 23, at an intermediate part of the switch connecting terminals 49 and the roof harness connecting terminals 50, pressure contact terminal parts 51 are provided which connect the electric wire under a pressure contact. The pressure contact terminal parts 51 serve to connect under a pressure contact operation the electric wire for supplying to an indoor lighting lamp the power supplied through the wire harness laid in the ceiling of the interior of the vehicle from a battery.

In a lower surface of the bus bar 23, fixing parts 52 are provided to fix the bus bar 23 to the bus bar holder 24.

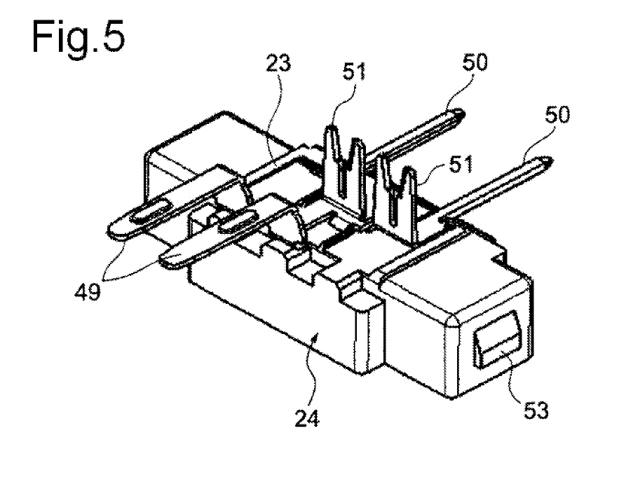

FIG. 5 shows the bus bar holder 24 to which the bus bar 23 is attached.

In the drawing, the bus bar 23 is attached to the bus bar holder 24 by fixing the bus bar 23 to the bus bar holder 24 by the fixing parts 52 and held by the bus bar holder 24 formed in the shape of a rectangular parallelepiped.

In one direction orthogonal to a longitudinal direction of the bus bar holder 24, the switch connecting terminals 49 protrude which are inserted into the terminal insert holes 48 formed in the front wall 45c of the switch 22 attached to the frontage 39 for the switch and are electrically connected to the switch 22. In the other direction, the roof harness connecting terminals 50 protrude which are connected to the wire harness wired in the ceiling of the interior of the vehicle and electrically connected to the battery to receive the supply of the power.

Further, in an upward direction orthogonal to the protruding directions of the switch connecting terminals 49 and the roof harness connecting terminals 50 of the bus bar holder 24, the pressure contact terminal parts 51 protrude that connect the electric wire under the pressure contact operation so as to be connected to the indoor lighting lamp.

On both side surfaces of the bus bar holder 24 in the longitudinal direction, engaging protrusions 53 are provided.

FIG. 6 shows an upper surface side (a lower surface side shown in FIG. 4) of the housing 21 shown in FIG. 4.

Referring to the drawing, the bus bar holder 24 to which the bus bar 23 is attached is attached to the housing 21 so that the pressure contact terminal parts 51 are located in a lower side (so that the pressure contact terminal parts 51 protrude downward under a state shown in FIG. 4) by deciding the upper side or the lower side of the bus bar holder 24 to which the bus bar 23 shown in FIG. 5 is attached.

The engaging protrusions 53 are engaged with engaging recessed parts not shown in the drawing which are formed in an inner surface of a bus bar holder attaching part 54 of the housing 21 so that the bus bar holder 24 is engaged with the housing 21.

The switch 22 is inserted into the frontage 39 for the switch from an upper part in FIG. 6.

Further, to the roof harness connector connecting part 37 of the housing 21, the roof harness connector 38 is detachably fitted. In the roof harness connector connecting part 37, a roof harness connector connecting frontage 55 is formed. To the roof harness connector connecting frontage 55, the roof harness connector 38 is inserted.

FIG. 7 shows a state that the bus bar holder 24 to which the bus bar 23 is fixed is attached to the housing 21 of the housing sub-assay 20.

FIG. 7 is a plan view of the housing sub-assay showing a state that the bus bar holder to which the bus bar is fixed is attached to the housing shown in FIG. 4.

In the housing 21, an electric wire holder frontage 56 is formed to insert an electric wire holder 58 between the frontage 39 for the switch and the roof harness connector connecting frontage 55 as shown in FIG. 4.

Further, to the housing 21, the bus bar holder 24 to which the bus bar 23 is attached is attached.

When the bus bar holder 24 to which the bus bar 23 is fixed is attached to the housing 21, the switch connecting terminals 49 of the bus bar 23 connected to the switch 22 are arranged so as to be exposed to the frontage 39 for the switch.

Further, the roof harness connecting terminals 50 of the bus bar 23 are arranged so as to be exposed to the roof harness connector connecting frontage 55.

Further, the pressure contact terminal parts 51 of the bus bar 23 for connecting the indoor lighting lamp are arranged so as to be exposed to the electric wire holder frontage 56.

Then, when the switch 22 is attached to the housing 21 to which the bus bar holder 24 having the bus bar fixed is attached, the switch connecting terminals 49 of the bus bar 23 are inserted into the terminal insert holes 48 formed in the front wall 45c of the switch 22 attached to the frontage 39 for the switch. Thus, the switch connecting terminals 49 are electrically connected to terminal parts of the switch 22.

Further, when the electric wire holder 58 of the connecting unit which supplies the power to the LED 107 as the indoor lighting lamp attached to the LED unit 100 is attached to the electric wire holder frontage 56, the electric wire 57 held by the electric wire holder 58 is connected to the pressure contact terminal parts 51 of the bus bar 23 under a pressure contact operation to supply the power to the indoor lighting lamp (the LED 107) through the wire harness laid in the ceiling of the interior of the vehicle from the battery.

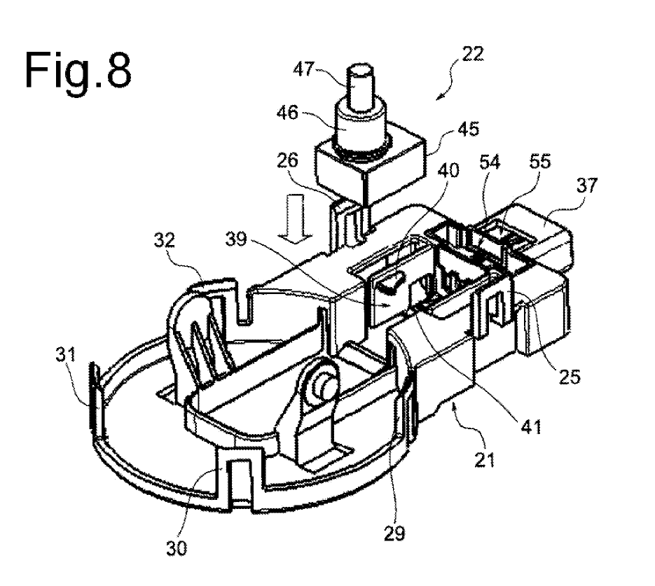

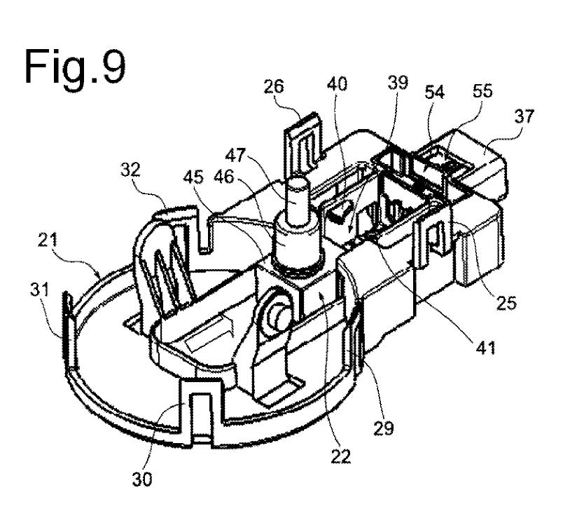

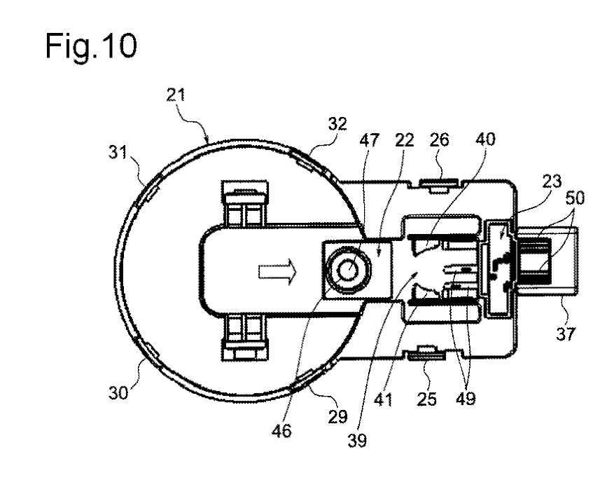

FIG. 8, FIG. 9 and FIG. 10 show a procedure for attaching the switch 22 to the housing 21 of the indoor lighting device for a vehicle 1.

In FIG. 8, the switch 22 having the main body case 45 arranged below and the push button 47 arranged above is inserted into the housing 21 from a direction shown by an arrow mark. When the switch 22 is attached to the housing 21, the switch 22 is inserted from the upper part of the housing 21 to a position nearer to a side that covers the ring member 11 where the switch does not abut on the switch fixing lock members 40 and 41 than to the switch fixing lock members 40 and 41 protruding inside both the side walls of the frontage 39 for the switch. Thus, as shown in FIG. 9 and FIG. 10, the switch 22 is attached before the frontage 39 for the switch.

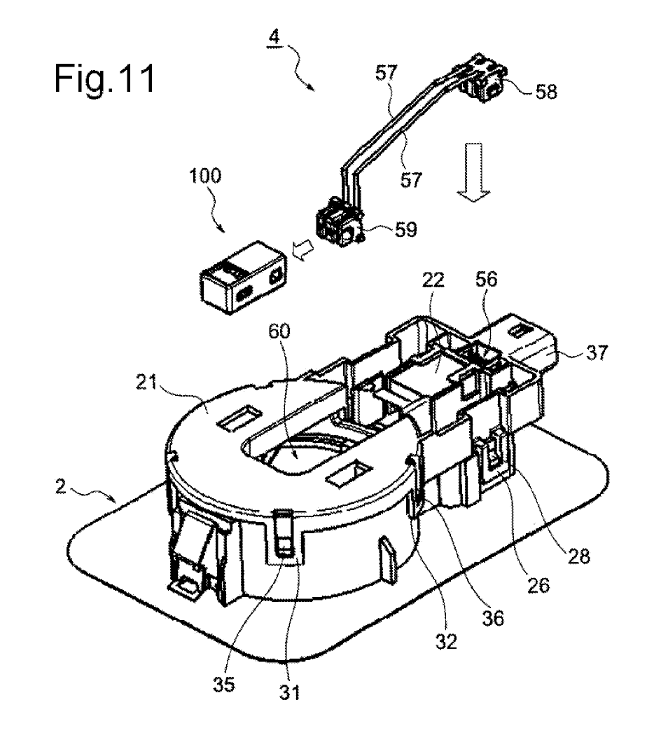

Then, as shown in FIG. 9 and FIG. 10, the switch 22 attached before the frontage 39 for the switch is slid and inserted, at this time, toward the frontage 39 for the switch from a direction shown by an arrow mark. The switch fixing lock members 40 and 41 protruding inside both the wall surfaces of the frontage 39 for the switch serve as guides by which the switch 22 is guided to the frontage 39 for the switch. Namely, the switch 22 is guided by a bottom surface of the housing 21 and the switch fixing lock members 40 and 41 and accommodated in the frontage 39 for the switch as shown in FIG. 11.

When the switch 22 is accommodated in the frontage 39 for the switch, the main body case 45 is pressed to be fixed and by the switch fixing lock members 40 and 41, so that the switch 22 is attached and fixed to the frontage 39 for the switch.

FIG. 11 shows the LED unit attached to the housing 21 of the indoor lighting device for a vehicle 1 and the connecting unit 4 that connects the LED attached to the LED unit to the LED unit sub-assay.

In the drawing, the connecting unit 4 serves to connect the LED unit sub-assay to the LED lamp, and includes two electric wires 57, the electric wire holder 58 attached to one ends of the two electric wires 57 and an electric wire holder 59 attached to the other ends of the two electric wires 57.

When the connecting unit 4 is attached to the housing 21, the electric wire holder 58 is attached to the electric wire holder frontage 56 provided in the housing 21. Further, the electric wire holder 59 is attached to the LED unit 100. The LED unit 100 is inserted into the indoor lighting device for a vehicle 1 from an opening 60 formed in the side of the housing 21 that covers the ring member 11 and attached to the housing 21.

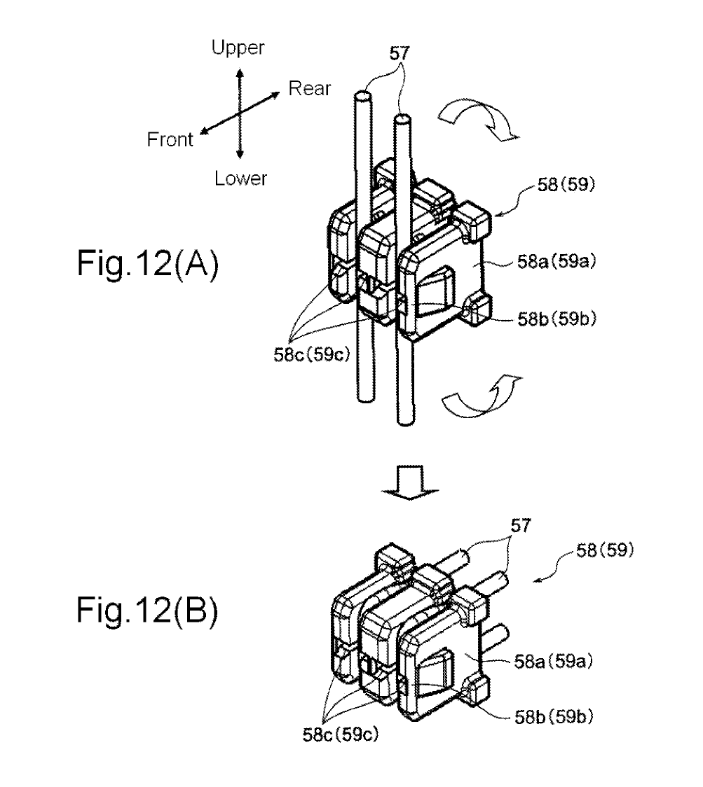

FIGS. 12 (A) and 12(B) show a detail of the electric wire holder 58(59) shown in FIG. 11.

In the drawing, the electric wire holder 58(59) is accommodated in the electric wire holder frontage 56 under a state that the electric wire holder 58 holds the bent parts of the electric wires 57 which are folded back and bent to electrically connect the electric wires 57 to the pressure contact terminal parts 51 in the electric wire holder frontage 56.

The electric wire holder 58(59) holds the two electric wires 57 electrically connected to a pair of pressure contact terminal parts 51. Further, the electric wire holder 58 (59) includes bent part holding parts 58a (59a) and lance parts 58b (59b).

The bent part holding parts 58a(59a) serve to hold the bent parts of the electric wires 57 which are respectively folded back and bent. The bent part holding parts 58a(59a) are formed so that the bent parts of the electric wires 57 are respectively inserted to a position in the electric wire holder frontage 56 where the bent parts of the electric wires 57 are respectively allowed to come into pressure contact with the pressure contact terminal parts 51. Further, the bent part holding parts 58a (59a) have in their front end parts cut-out parts 58c (59c) formed so that the pressure contact terminal parts 51 are connected to the electric wires 57.

The lance parts 58b(59b) are engaged, as engaging parts, with engaging parts formed in the electric wire holder frontage 56 to fix the electric wire holder 58 (59) to the electric wire holder frontage 56.

When the electric wire holder 58(59) is accommodated in the electric wire holder frontage 56 under a state the electric wires 57 are respectively bent and held, namely, when the electric wire holder 58(59) is engaged with the LED unit sub-assay by the engaging parts, the bent parts of the electric wires 57 respectively held by the electric wire holder 58(59) are electrically connected to the one pair of pressure contact terminal parts 51.

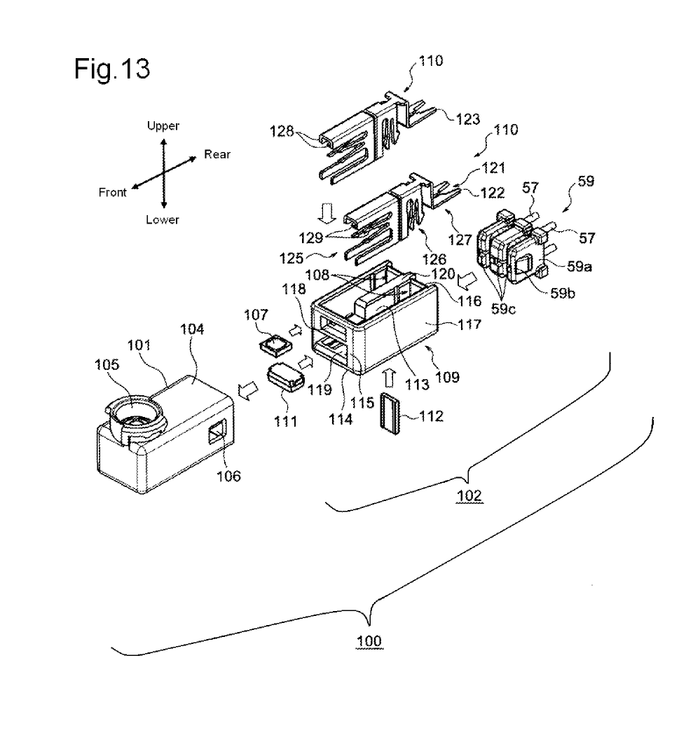

FIG. 13 shows an entire structure of the LED unit 100 attached to the indoor lighting device for a vehicle shown in FIG. 11.

In the drawing, the LED unit 100 includes a unit housing 101 and a connecting structure 102 of electronic parts as a connecting unit of the electronic parts.

The unit housing 101 serves to accommodate the connecting structure 102 of the electronic parts and the electric wire holder 59 to which the electric wires 57 shown in FIG. 11 are connected. The unit housing 101 is a box shaped casing which has an opening 104 formed as an insert hole for accommodating the connecting structure 102 of the electronic parts and the electric wire holder 59 therein. Further, in the unit housing 101, the connecting structure 102 of the electronic parts is arranged. The unit housing 101 includes a lighting opening part 105 and an engaging opening part 106.

The electric wire holder 59 to which the electric wires 57 shown in FIG. 11 are connected is inserted into the unit housing 101 to be electrically connected to the LED 107.

The lighting opening part 105 is an opening provided on a wall forming an upper surface of the unit housing 101 to output to an external part lights emitted from the LED 107 accommodated in the unit housing 101. The lighting opening part 105 may have a structure covered with a light transmitting member such as a lens.

The engaging opening part 106 is an opening formed in a side wall in the vicinity of the opening 104 of the unit housing 101. The engaging opening part 106 is engaged with the lance parts 59b provided in the electric wire holder 59 as the engaging parts. Namely, when the engaging opening part 106 is engaged with the lance parts 59b, the connecting structure 102 of the electronic parts and the electric wire holder 59 can be fixed in the unit housing 101.

The connecting structure 102 of the electronic parts includes an electronic part accommodating housing 109 and a pair of terminals 110 accommodated in the electronic part accommodating housing 109. The connecting structure 102 of the electronic parts electrically connects together the electronic parts accommodated in the electronic part accommodating housing 109 by the one pair of terminals 110 fixed to the electronic part accommodating housing 109.

Namely, the connecting structure 102 of the electronic parts electrically connects the LED 107, a Zener diode 111 and a resistance plate 112 together and accommodates them in the electronic part accommodating housing 109.

The electronic part accommodating housing 109 is formed with an insulating material, and is a box shaped casing having an opening part 113 formed on an upper surface. The electronic part accommodating housing 109 includes a rectangular bottom wall 114, a front wall 115, a rear wall 116 opposed to the front wall 115 and a pair of opposed right and left walls 117 which are side walls respectively standing upright from four sides of the bottom wall 114.

In the electronic part accommodating housing 109, an LED element insert opening 118 and a Zener diode insert opening 119 are provided in the front wall 115 and a resistance plate insert opening (not shown in the drawing) is provided in the bottom wall 114. In the electronic part accommodating housing 109 as the casing, a separation wall 120 is provided inward at a center in the direction of width.

Further, in the rear wall 116 of the electronic part accommodating housing 109, electric wire holder attaching parts 108 are provided to which the electric wire holder 58 of the connecting unit 4 is attached.

The LED element insert opening 118 is an opening formed in the front wall 115 to insert the LED 107 into the electronic part accommodating housing 109.

The Zener diode insert opening 119 is an opening formed in the front wall 115 to insert the Zener diode 111 into the electronic part accommodating housing 109.

The resistance plate insert opening is an opening formed in the bottom wall 114 to insert the resistance plate 112 into the electronic part accommodating housing 109.

The one pair of terminals 110 are two terminals having the same forms. The one pair of terminals 110 are arranged in the electronic part accommodating housing 109 in such a way that a position of an end part 122 where a below-described pressure contact terminal part 121 is formed and a position of an end part 123 opposed to the end part 122 are arranged in parallel. Further, the one pair of terminals 110 are accommodated in the electronic part accommodating housing 109 so that the pressure contact terminal parts 121 are respectively exposed outside the electronic part accommodating housing 109 through the opening part 113 and stand upright on an outer surface of the rear wall 116 of the electronic part accommodating housing 109.

Each of the one pair of terminals 110 is integrally formed by a press work process of an electrically conductive plate shaped member. As shown in FIG. 13, the terminal 110 includes a first parts connecting part 125 and a second parts connecting part 126 formed by bending downward both sides extending in a longitudinal direction of a rectangular top plate part 124 and an electric wire connecting part 127 formed by bending a rear end part of the top plate part 124 downward and further bending the rear end part rearward. Further, the top plate part 124 has a pair of bent edge parts 128 formed by bending downward both edges which form both the sides extending in the longitudinal direction of the top plate part 124.

An LED element connecting part holds and fixes the LED 107 by the pair of bent edge parts 128 of the top plate part 124 and a pair of first contact pieces 129. Namely, when the LED 107 is inserted between the one pair of bent edge parts 128 and the one pair of first contact pieces 129, the LED 107 is held and fixed by using an elasticity of the one pair of first contact pieces 129 and the one pair of terminals 110 are electrically connected to the LED 107.

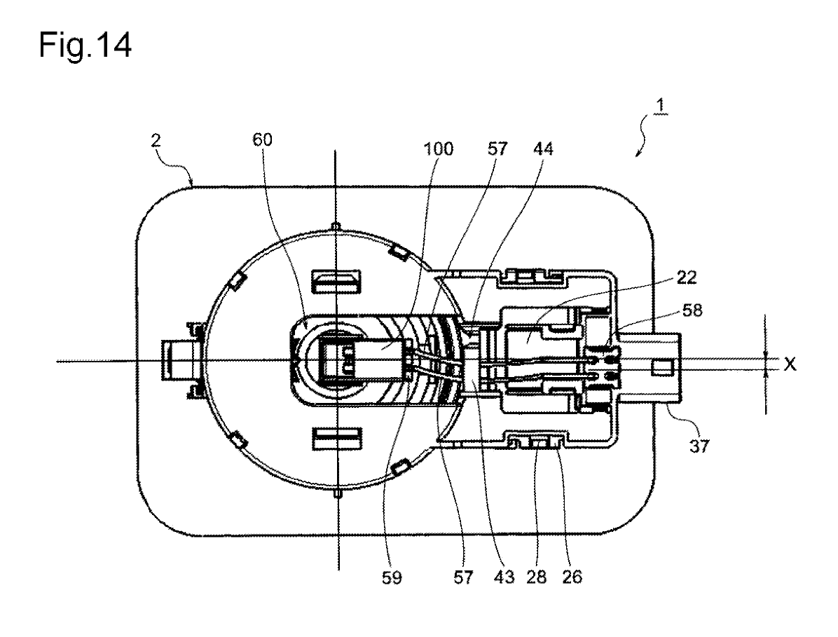

Now, referring to FIG. 14, when the connecting unit 4 having the electric wire 58 attached to the LED unit 100 is attached to the housing 21 of the indoor lighting device for a vehicle 1, an explanation is given to an accommodation of the electric wires 57 of the connecting unit 4 in the electric wire accommodating part 42. FIG. 14 shows the indoor lighting device for a vehicle 1 in which the LED unit sub-assay is accommodated in the LED lamp sub-assay 2 to which the LED is attached and the LED lamp sub-assay 2 is connected to the LED unit sub-assay.

When the indoor lighting device for a vehicle 1 is formed, the bus bar holder 24 to which the bus bar 23 is attached as shown in FIG. 5 is attached to the bus bar holder attaching part 54 of the housing 21 of the housing sub-assay 20 as shown in FIG. 6. When the bus bar holder 24 is attached to the bus bar holder attaching part 54, the roof harness connecting terminals 50 protruding from the bus bar holder 24 protrude to the roof harness connector connecting frontage 55 of the housing 21. The switch connecting terminals 49 protrude to the frontage 39 for the switch. The pressure contact terminal parts 51 protrude to the electric wire holder frontage 56 of the housing 21.

Then, the switch 22 is accommodated in the frontage 39 for the switch of the housing 21 of the housing sub-assay 20 as shown in FIGS. 8, 9 and 10 by guiding the switch by the switch fixing lock members 40 and 41 and the clamp member 43. When the switch 22 is set to the frontage 39 for the switch of the housing 21, the switch 22 is connected to the switch connecting terminals 49 of the bus bar 23 protruding from the bus bar holder 24.

The LED unit holder 18 is attached to the design lens 15 as shown in FIG. 3. The design lens 15 is attached to the lighting vessel 13. The lighting vessel 13 is attached to the ring member 11. Then, the housing sub-assay 20 to which the switch 22 and the bus bar holder 24 are attached as described above is attached to the vessel for the roof 10 so as to cover the ring member 11 and the switch knob attaching part 16. Thus, the LED lamp sub-assay 2 as shown in FIG. 11 is obtained.

As described above, after the housing sub-assay 20 to which the switch 22 and the bus bar holder 24 are attached is attached to the vessel for the roof 10, the LED unit 100 and the connecting unit 4 are attached to the LED lamp sub-assay 2 as shown in FIG. 11.

When the LED unit 100 and the connecting unit 4 are attached to the LED lamp sub-assay 2, the electric wire holder 59 of the connecting unit 4 is previously attached to the electric wire holder attaching parts 108 of the electronic part accommodating housing 109 of the LED unit 100.

In the connecting unit 4 having the electric holder 59 to which the LED unit 100 is attached, the LED unit 100 attached to the electric wire holder 59 is initially attached from an opening 60 formed in the housing 21 of the housing sub-assay 20 to set the LED 107 so as to be located above the design lens 15.

After that, the electric wire holder 58 is attached to the electric wire holder frontage 56 provided in the housing 21.

When the connecting unit 4 is attached to the LED lamp sub-assay 2, the electric wires 57 that connect the electric wire holder 58 to the electric wire holder 59 are arranged in an upper side of the clamp member 43 of the housing 21. Then, the electric wires 57 of the connecting unit 4 are allowed to pass through an inside of the clamp member 43 and arranged through the electric wire attaching opening 44 as shown in FIG. 14.

After the electric wires 57 of the connecting unit 4 are allowed to pass through the electric wire attaching opening 44, the electric wires 57 are allowed to pass through the inside of the clamp member 43. Accordingly, the LED 100 is formed so as to be movable with respect to a rotation axis A and a rotation axis B shown in FIG. 14. The electric wire attaching opening 44 is not arranged on a straight line relative to the rotation axis A. Further, the electric wire attaching part 108 is not arranged on the straight line relative to the rotation axis A. Accordingly, both the electric holder attaching part 108 and the electric wire attaching opening 44 are not arranged on the straight line relative to the rotation axis A. The electric wire holder attaching part 108 and the electric wire attaching opening 44 are arranged so as not to correspond to a wiring direction in the electric wires 57 are provided and extended. The electric wire holder attaching part 108 is arranged in an opposite side to the electric wire attaching opening 44.

The electric wire holder frontage 56 is offset by X to a base side of the clamp member 43 relative to the electric wire holder attaching part 108.

Accordingly, since the electric wires 57 of the connecting unit 4 are arranged on the upper side of the clam member 43, and then, allowed to pass through the electric wire attaching opening 44 so as to be arranged in the inside of the clamp member 43, the electric wires 57 can be easily fixed. Further, since the electric wires 57 of the connecting unit 4 are allowed to pass through the electric wire attaching opening 44, and then, pass through the inside of the clamp member 43, the electric wires 57 can hardly slip off from the clamp member 43.

Further, since the electric wire holder frontage 56 is offset to the base side of the clamp member 43, the electric wires 57 of the connecting unit 4 can be arranged in the base side of the clamp member 43. Thus, the electric wires 57 can hardly slip off from the clamp member 43.

Further, when the switch 22 is attached to the housing 21, since the switch 22 is guided by the switch fixing lock members 40 and 41 and the clamp member 43 provided in the housing 21, the switch 22 can be easily attached to the housing 21.

The present invention is not restricted by the embodiment.

This application is based upon claims the benefit of priority of Japanese Patent Application No. 2011-107472 filed on May 12, 2011, the contents of which are incorporated herein by reference.

### INDUSTRIAL APPLICABILITY

According to the present invention, the electric wire can be hardly slipped off from the housing.

Further, according to the present invention, the workability can be improved when the switch is attached to the housing.

### REFERENCE SIGNS LIST

1 . . . indoor lighting device for vehicle
2 . . . LED lamp sub-assay
4 . . . connecting unit
21 . . . housing
22 . . . switch
23 . . . bus bar
24 . . . bus bar holder
38 . . . roof harness connector
39 . . . frontage for switch
40, 41 . . . switch fixing lock member
43 . . . clamp member
44 . . . electric wire attaching opening
49 . . . switch connecting terminal
50 . . . roof harness connecting terminal
51 . . . pressure contact terminal part
57 . . . electric wire
100 . . . LED unit
107 . . . LED
108 . . . electric wire holder attaching part

1. An indoor lighting device for a vehicle in which an LED unit to which an LED is attached is attached to a housing and a bus bar holder to which a bus bar is fixed for electrically connecting the LED to a roof harness is attached to the housing to turn on the LED and light an interior of the vehicle,
wherein the bus bar includes switch connecting terminals provided in one end side which are electrically connected to a switch, roof harness connecting terminals electrically connected to the roof harness wired in the ceiling of the interior of the vehicle to receive a supply of power and pressure contact terminal parts provided in an intermediate part of the switch connecting terminals and the roof harness connecting terminals to connect an electric wire under a pressure contact,
the switch connecting terminals of the bus bar are arranged so as to protrude to a frontage for switch of the housing,
the pressure contact terminal parts of the bus bar are arranged so as to protrude to an electric wire holder attaching part of the housing, a clamp member is provided in the housing,
a part of the clamp member is cut out to form an electric wire attaching opening through which the electric wire passes, and
an electric wire holder attaching part of the LED unit and the electric wire attaching opening of the housing are arranged so as not to correspond to a wiring direction of the electric wire and the electric wire is allowed to pass through an inside of the clamp member so as to be clamped.

2. The indoor lighting device for a vehicle according to claim 1, wherein the bus bar includes the switch connecting terminals, the switch connecting terminals are arranged so as to be exposed to the frontage for the switch of the housing, the switch is attached to the housing so that the switch connecting terminals are connected and fixed to terminal parts of the switch, and the clamp member forms a guide part in the direction of height when the switch is attached to the frontage for the switch of the housing.

3. The indoor lighting device for a vehicle according to claim 2, wherein in the frontage for the switch of the housing, switch fixing lock members are formed to protrude inside both wall surfaces and the switch fixing lock members form a guide part by holding the switch together with the clamp member when the switch is attached to the frontage for the switch.
